(19) United States
(12) Patent Application Publication
(10) Pub. No.: US 2026/0054667 A1
(43) Pub. Date: Feb. 26, 2026

(54) SYSTEMS AND METHODS FOR CONTROLLING OPERATION OF MULTIPLE VEHICLE AUTOMATIONS

(71) Applicant: Ford Global Technologies, LLC, Dearborn, MI (US)

(72) Inventors: Russell Andres, Riverview, MI (US); Alexandra Alioto, Bloomfield Hills, MI (US); Lisa Gentile, Ave Maria, FL (US)

(73) Assignee: Ford Global Technologies, LLC, Dearborn, MI (US)

(21) Appl. No.: 18/810,771

(22) Filed: Aug. 21, 2024

(51) Int. Cl. B60R 16/037; B60R 16/023

(52) U.S. Cl. CPC B60R 16/037; B60R 16/023

(57) ABSTRACT

A vehicle including a transceiver and a processor is disclosed. The transceiver may receive trigger signals associated with activation and deactivation of a plurality of automation modes. The processor may obtain a first trigger signal for a request to activate a first automation mode and a second trigger signal for a request to activate a second automation mode. The processor may further determine first optimal operational states for a first set of vehicle components associated with the first automation mode, and second optimal operational states for a second set of vehicle components associated with the second automation mode. Furthermore, the processor may cause the first set of vehicle components to operate in the first optimal operational states and the second set of vehicle components to operate in the second optimal operational states simultaneously, when no vehicle component is common between the first and second sets of vehicle components.

### FIELD

The present disclosure relates to systems and methods for controlling operation of multiple vehicle automations simultaneously.

### BACKGROUND

Many modern vehicles enable users to activate one or more vehicle automation modes based on user's requirements, which causes automatic adjustment of vehicle components for user's convenience. For example, when a user desires to watch a movie in a vehicle, the user may activate a vehicle's cinema/movie mode, which may cause the vehicle to automatically adjust operational states of vehicle's interior lights, sound systems, windows, etc. to enable the user to comfortably view the movie. Such operational states of vehicle components for each automation mode may be defined by a vehicle manufacturer, and/or may be set or customized by the user as per user's preference.

While the automation modes provide many benefits to the users, there are instances where the users may desire additional features to further enhance user's experience of using the automation modes in the vehicle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of a system to control operation of multiple vehicle automation modes simultaneously in accordance with the present disclosure.

FIG. 3 depicts an example first sequence flow diagram showing transition of vehicle component operational states in accordance with the present disclosure.

FIG. 4 depicts an example second sequence flow diagram showing transition of vehicle component operational states in accordance with the present disclosure.

FIG. 5 depicts an example third sequence flow diagram showing transition of vehicle component operational states in accordance with the present disclosure.

FIG. 6 depicts a flow diagram of an example first method to control vehicle component operation in accordance with the present disclosure.

FIG. 7 depicts a flow diagram of an example second method to control vehicle component operation in accordance with the present disclosure.

FIG. 8 depicts a flow diagram of an example third method to control vehicle component operation in accordance with the present disclosure.

FIG. 9 depicts a flow diagram of an example fourth method to control vehicle component operation in accordance with the present disclosure.

### DETAILED DESCRIPTION

### Overview

The present disclosure describes a vehicle that may enable a user to conveniently activate or deactivate one or more automation modes simultaneously in the vehicle. Specifically, the vehicle may enable the user to “build” a list or stack of automation modes that may run/execute concurrently in the vehicle. In some aspects, the user may transmit, via a user device or a vehicle Human-Machine Interface (HMI), requests or trigger signals to the vehicle to activate or deactivate one or more automation modes. For example, the user may transmit a first trigger signal to the vehicle to execute a first automation mode (e.g., a “cinema mode” or a “movie mode”; the terms “cinema mode” and “movie mode” are used interchangeably in the present disclosure), and a second trigger signal to the vehicle to execute a second automation mode (e.g., a “reading mode”) simultaneously with the first automation mode. The user may transmit the first and second trigger signals at the same time, or in a sequential manner. In other aspects, one or more vehicle systems or units may automatically generate these first and second trigger signals, based on preset vehicle operating conditions (e.g., based on vehicle speed, or other vehicle operating parameters). In this case, these systems may transmit the trigger signals to the vehicle.

Responsive to obtaining the first and second trigger signals from the user, the vehicle may cause a first set of vehicle components associated with the first automation mode to operate in first optimal operational states and second set of vehicle components associated with the second automation mode to operate in second optimal operational states simultaneously, when no vehicle component may be common between the first and second sets of vehicle components.

When one or more vehicle components are common between the first and second sets of vehicle components, the vehicle may first determine a priority order of activating the first and second automation modes, responsive to obtaining the first and second trigger signals. In some aspects, the priority order may be based on a sequence in which the first and second trigger signals are obtained by the vehicle. For example, if the second trigger signal is obtained after the first trigger signal, the vehicle may determine that the second automation mode has a higher priority than the first automation mode. In other aspects, the priority order may be based on user inputs or user preferences.

Responsive to determining the priority order, the vehicle may cause the vehicle components common between the first and second sets of vehicle components to operate according to the automation mode having the higher priority. For example, if the second automation mode has a higher priority than the first automation mode, the vehicle may cause the “common” vehicle components to operate according to the operational states defined for the second automation mode.

In further aspects, the vehicle may enable the user to deactivate an automation mode, when the other automation modes may still be running/executing in the vehicle. For example, the user may transmit, via the user device or the HMI, a deactivation request to the vehicle for deactivating the first automation mode, when the second automation mode may still be running in the vehicle. In this case, responsive to obtaining the deactivation request, the vehicle cause the vehicle components associated with the first automation mode to revert to their pre-automation operational state (i.e., when no automation was being executed in the vehicle), or to their default operational state (which may be defined by the user), or to an operational state defined by an automation mode that may have a lower priority than the first automation mode (e.g., a predecessor automation mode).

The vehicle may further store a priority position associated with the first automation mode in the priority order, responsive to obtaining the deactivation request for the first automation mode. The vehicle may use the priority position for restoring the operational states of the vehicle components associated with the first automation mode, when the user transmits a reactivation request to the vehicle to reactivate the first automation mode.

The vehicle may further enable the user to set preferred operational states of one or more vehicle components when the automation modes may be running/executing in the vehicle. In some aspects, the vehicle may cause such vehicle components to retain their user preferred operational states when the respective automation modes may be deactivated in the vehicle.

The present disclosure discloses a vehicle that enhances user's experience and comfort of operating vehicle's automation modes. The vehicle enables the user to execute multiple automation modes simultaneously in the vehicle. Further, the vehicle may store priority position of an automation mode in the priority order when the automation mode is deactivated, so that the vehicle may restore the operational states of vehicle components associated with the automation mode when the automation mode is reactivated. This considerably enhances user's convenience of reactivating an automation mode. The vehicle may further restore operational states of vehicle components to their respective pre-automation operational states or user-defined default operational states, when the user deactivates the automation modes running in the vehicle. This eliminates the need for the user to manually restore operational states of vehicle components when the automation modes are deactivated.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

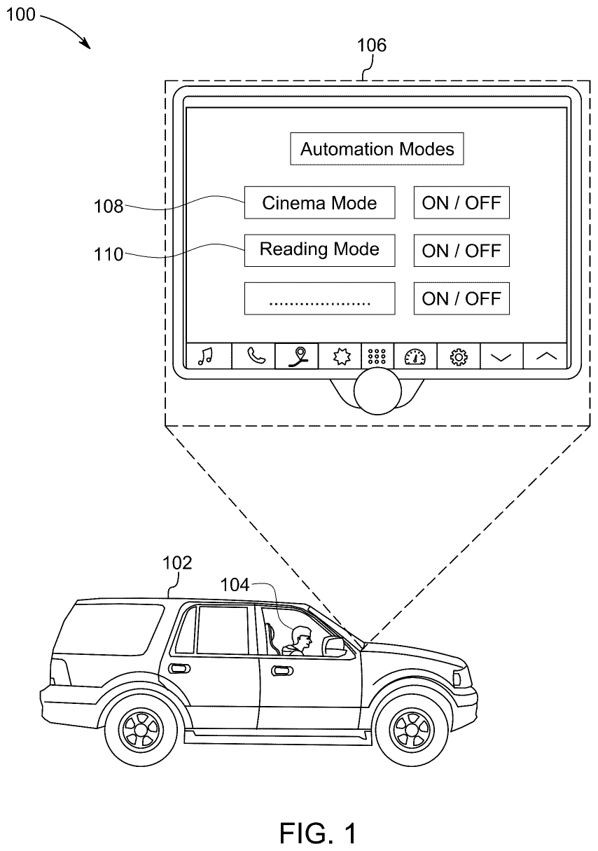

FIG. 1 depicts an example environment 100 in which techniques and structures for providing the systems and methods disclosed herein may be implemented. The environment 100 may include a vehicle 102 and a user 104 who may be located inside the vehicle 102. In the exemplary aspect depicted in FIG. 1, the user 104 is shown to be sitting on a driver sitting area; however, the present disclosure is not limited to such an aspect. The user 104 may be sitting on a passenger sitting area, a rear sitting area, or the like, without departing from the present disclosure scope.

The vehicle 102 may take the form of any passenger or commercial vehicle such as a car, a work vehicle, a crossover vehicle, a truck, a van, a minivan, a taxi, a bus, etc. The vehicle 102 may be a manually driven vehicle or may be configured to operate in a partially/fully autonomous mode. Further, the vehicle 102 may include any powertrain such as a gasoline engine, one or more electrically-actuated motor(s), a hybrid system, etc.

In some aspects, the vehicle 102 may enable the user 104 to select and execute one or more automation modes associated with the vehicle 102 independently or simultaneously, which may cause the vehicle 102 to automatically adjust operational states of one or more vehicle components based on the automation mode(s) selected by the user 104. As an example, the user 104 may select a “cinema mode” when the user 104 desires to watch a movie while sitting in the vehicle 102, a “reading mode” when the user 104 desires to read, a “cool comfort mode” when the user 104 desires the vehicle 102 to create a cool and comforting ambience in a vehicle interior portion, and/or the like.

Responsive to the user 104 selecting an automation mode to execute, the vehicle 102 may automatically adjust operational states of one or more vehicle components that may be associated or mapped with the selected automation mode. For example, when the user 104 selects the “cinema mode”, the vehicle 102 may automatically cause the vehicle's interior lights to illuminate in blue color, vehicle's fan speed to turn low, vehicle's interior temperature to get adjusted to 72-75 degrees Fahrenheit, vehicle's sitting area on which the user 104 is sitting to get heated, vehicle's top portion window to close, and/or the like. Similarly, when the user 104 selects the “reading mode”, the vehicle 102 may automatically cause the vehicle's interior lights to illuminate in purple color, vehicle's sitting area on which the user 104 is sitting to tilt up, vehicle's top portion window to turn to vent, and/or the like. As another example, when the user 104 selects the “cool comfort mode”, the vehicle 102 may automatically close the vehicle's windows, lower the vehicle's temperature, close the vehicle's top portion window, and/or the like.

The vehicle components whose operational states should get adjusted for each automation mode, and the respective optimal operational states for the vehicle components may be preset by a vehicle manufacturer and/or may be set/customized by the user 104. For example, the vehicle manufacturer and/or the user 104 may pre-set the respective optimal operational states of one or more vehicle components for each automation mode, such as the “cinema mode”, the “reading mode”, the “cool comfort mode”, etc., as described above.

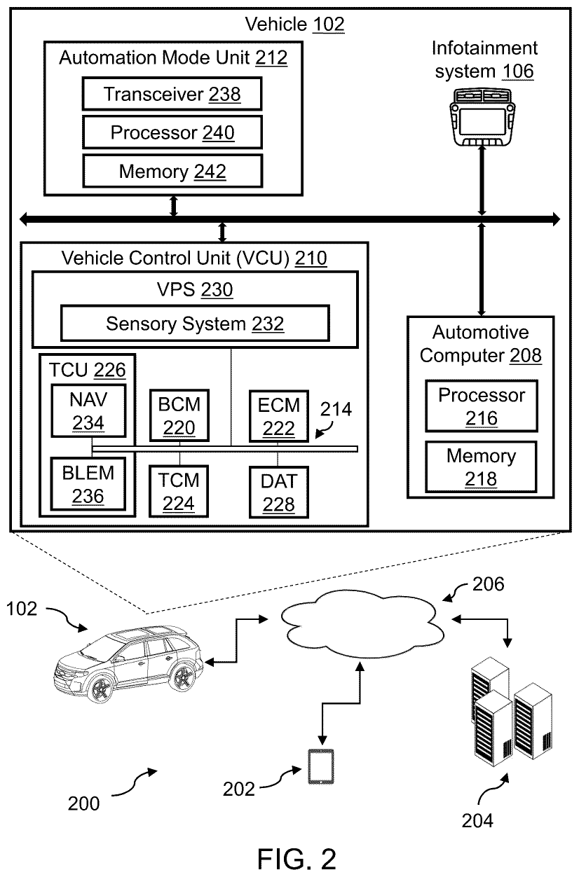

The user 104 may select to execute an automation mode by transmitting a trigger signal or a request to the vehicle 102 to activate the automation mode via a user device (shown as user device 202 in FIG. 2), a vehicle Human-Machine Interface 106 (or HMI 106), and/or the like. In the exemplary aspect depicted in FIG. 1, the HMI 106 is shown to display a plurality of automation modes, e.g., a cinema mode 108, a reading mode 110, etc. In some aspects, the user 104 may select one or more automation modes on the HMI 106 to cause the vehicle 102 to execute the selected automation mode(s). In additional or alternative aspects, the vehicle 102 may automatically execute an automation mode based on trigger signals obtained from or generated by a vehicle control unit (shown as VCU 210 in FIG. 2) and user preferences preset by the user 104 in the vehicle 102. For example, when the user 104 prefers the “cool comfort mode” to automatically get executed in the vehicle 102 when the vehicle's speed drops below 5 miles an hour, the VCU may generate a trigger signal when the vehicle's speed drops below 5 miles an hour. In this case, the vehicle 102 may automatically activate and execute the “cool comfort mode” responsive to the VCU generating the trigger signal.

In some aspects, multiple different trigger signals (e.g., one or more trigger signals generated by the VCU, alongside user requests) may cause the vehicle 102 to execute an automation mode, e.g., for small time durations. In a similar manner, multiple different automation modes may get executed by the vehicle 102 based on a single trigger signal generated by the VCU.

In some aspects, the vehicle 102 may enable the user 104 to select and execute multiple automation modes simultaneously in the vehicle 102. In this case, the vehicle 102 may enable the user 104 to overlap or stack multiple automation modes and/or define a priority order in which the automation modes should be executed in the vehicle 102. In an exemplary aspect, when the user 104 desires multiple automation modes to get executed simultaneously in the vehicle 102, the user 104 may transmit, via the user device or the HMI 106, a multiple automation mode request to the vehicle 102. Responsive to obtaining the multiple automation mode request from the user 104, the vehicle 102 may determine/understand that the user 104 desires multiple automation modes to execute simultaneously in the vehicle 102. In this case, responsive to obtaining the multiple automation mode request from the user 104, the vehicle 102 may incrementally update configurations/operational states of additional vehicle components as the user 104 adds or selects additional automation modes, based on the priority order of respective operational modes in the list/stack of operational modes that may be getting executed in the vehicle 102. In this manner, as an example, an automation mode that configures or controls operation of vehicle lights and sound system may build on sitting area configurations/operational states set by a prior/previous automation mode that may already be getting executed in the vehicle 102.

The vehicle 102 may enable the automation modes to execute “on top of” each other, without requiring the user 104 to deactivate a previous automation mode to execute a new automation mode. The vehicle 102 may also enable the user 104 to deactivate any one or more automation modes anytime, from the list/stack of operational modes that may be getting executed in the vehicle 102. When an automation mode is deactivated by the user 104, the operational states of the vehicle components that are associated with or mapped to the deactivated automation mode may revert or “go back” to their previous operational states before the automation mode was activated. Specifically, when an automation mode is deactivated, the vehicle 102 may cause the vehicle components that are associated with the deactivated automation mode to operate in their “pre-automation operational states”. In an exemplary aspect, a pre-automation operational state for a vehicle component may indicate an operational state of the vehicle component before the automation mode was activated or before the vehicle component was caused to operate in an optimal operational state associated with the automation mode. In some aspects, the vehicle 102 may also cause one or more vehicle components that are associated with the deactivated automation mode to operate in their preset default operational states, if such default operational states are defined/set by the user 104.

Examples of adjustment of operational states of vehicle components upon activation and/or deactivation of one or more automation modes (when the vehicle 102 enables multiple automation modes to get executed simultaneously) are described below. The examples described below are for illustrative purpose, and should not be construed as limiting.

In a first example, the user 104 may enable a multiple automation mode activation setting in the vehicle 102 or transmit (via the user device or the HMI 106) the multiple automation mode request to the vehicle 102, and may then transmit a first trigger signal/request to execute the cool comfort zone. Responsive to obtaining the first trigger signal from the user 104, the vehicle 102 may close the vehicle's windows and the top portion window, and cool the vehicle's interior portion to a comfortable/refreshing temperature (e.g., between 72 to 75 degrees Fahrenheit). Thereafter, the user 104 may transmit a second trigger signal to the vehicle 102 to execute the reading mode 110. Responsive to obtaining the second trigger signal, the vehicle 102 may retain or not change the operational states of the vehicle components described above associated with the cool comfort mode, and may additionally turn ON a warm vehicle interior light. In this case, there may be no vehicle components common between the cool comfort mode and the reading mode 110, and hence the vehicle 102 may independently and simultaneously enable the vehicle components to operate in the operational states associated with their respective automation modes.

The user 104 may then transmit a third trigger signal to the vehicle 102 to execute the cinema mode 108. Responsive to obtaining the third trigger signal, the vehicle 102 may retain or not change the operational states of the vehicle components described above associated with the cool comfort mode, but may dim the vehicle interior light. In addition, the vehicle 102 may commence playing or outputting a preset media/audio file from the HMI 106, responsive to obtaining the third trigger signal. In this case, while there may be no common vehicle components between the cool comfort mode and the cinema mode 108, the control of the vehicle interior lights may be common between the cinema mode 108 and the reading mode 110. In this case, responsive to determining that there may a common vehicle component between two automation modes selected by the user 104 to execute, the vehicle 102 may determine the priority order of activating the two automation modes (e.g., the cinema mode 108 and the reading mode 110). In some aspects, the vehicle 102 may activate the operation of the “common” vehicle component based on the operational state associated with the automation mode that has a higher priority. In the example described above, the vehicle 102 dims the vehicle interior light responsive to obtaining the third trigger signal, as the cinema mode 108 may have a higher priority of activation than the reading mode 110.

In some aspects, the priority order may be based on a sequence or order in which the trigger signals or requests for activation are obtained/received by the vehicle 102. For example, in the aspect described above, since the third trigger signal is obtained after the second trigger signal, the priority order associated with the third trigger signal or the cinema mode 108 may be higher than the priority order associated with the second trigger signal or the reading mode 110. In alternative aspects, the priority order may be set/defined by the user 104 when the user 104 transmits the trigger signals (e.g., the first, second and third trigger signals described above) to the vehicle 102 or when the user 104 may be “building” a list/stack of automation modes to be executed simultaneously by the vehicle 102 on the user device or the HMI 106.

In a second example, the user 104 may transmit (via the user device or the HMI 106) a first trigger signal to the vehicle 102 to execute a mode that illuminates vehicle lights for visibility. Responsive to obtaining the first trigger signal, the vehicle 102 may turn ON the vehicle lights. Thereafter, the user 104 may transmit a second trigger signal to execute a new mode that is ambivalent about the state of lighting. Responsive to obtaining the second trigger signal, the vehicle 102 may control/adjust operational states of one or more vehicle components associated with the new mode, while retaining the illumination state associated with the vehicle lights (instead of automatically switching OFF the lights when the new mode is activated/executed).

In a third example, the user 104 may transmit (via the user device or the HMI 106) a first trigger signal to the vehicle 102 to execute the cinema mode 108, which may cause the vehicle 102 to switch OFF the vehicle lights. The user 104 may then manually turn ON the lights in the vehicle 102 (as it may be getting dark in the vehicle interior portion). The user 104 may then transmit a deactivation request to the vehicle 102 to deactivate or switch OFF the cinema mode 108. Responsive to obtaining the deactivation request, the vehicle 102 may restore operational states of other vehicle components associated with the cinema mode 108 to their respective pre-automation operational states; however, the vehicle 102 may keep the vehicle lights turned ON irrespective of the light's pre-automation operational state. In this case, the vehicle 102 may give preference to the user defined or user preferred operational state of a vehicle component (e.g., the vehicle lights) instead of its pre-automation operational state, while deactivating the automation mode (e.g., the cinema mode 108).

In a fourth example, the user 104 may transmit (via the user device or the HMI 106) a first trigger signal to the vehicle 102 to execute a first automation mode, which may cause the vehicle 102 to configure or adjust operational states of vehicle windows and mirrors, and disable the vehicle lights. The user 104 may then transmit a second trigger signal to the vehicle 102 to execute a second automation mode, which may cause the vehicle 102 to open the vehicle's top portion window and turn ON the vehicle lights. In this case, since the vehicle 102 obtains the second trigger signal after obtaining the first trigger signal, the priority order associated with the second automation mode is higher than the first automation mode, and hence the vehicle 102 turns ON the vehicle lights (which may be the light's optimal operational state in the second automation mode) as opposed to keeping the lights in the disabled state (which may be the light's optimal operational state in the first automation mode).

The user 104 may then transmit a third trigger signal to the vehicle 102 to execute a third automation mode, which may change the operational state associated with the vehicle windows. The user 104 may then transmit a deactivation request to deactivate/switch OFF the second automation mode. Responsive to obtaining the deactivation request, the vehicle 102 may restore operational state associated with the vehicle's top portion window to its original state (i.e., the pre-automation operational state) before the first automation mode was activated, while retaining the operational states of the mirrors and the vehicle lights as defined by or associated with the first automation mode and the window state as defined by or associated with the third automation mode. Stated another way, when the vehicle 102 obtains the deactivation request to deactivate the second automation mode, the vehicle 102 restores operational states of all the vehicle components associated with the second automation mode to their respective pre-automation operational states (i.e., before the vehicle components started to operate in the second automation mode).

The vehicle 102 may further enable the user 104 to provide user preferences associated with operational states of one or more vehicle components, reactivate an automation mode after deactivating it, change priority order of automation modes, and/or the like. Such additional vehicle details are described below in conjunction with FIG. 2.

The vehicle 102 and/or the user 104 implement and/or perform operations, as described here in the present disclosure, in accordance with the owner manual and safety guidelines. In addition, any action taken by the user 104 based on the notifications/recommendations provided by the vehicle 102 should comply with all the rules specific to the location and operation of the vehicle 102 (e.g., Federal, state, country, city, etc.). The notifications/recommendations, as provided by the vehicle 102, should be treated as suggestions and only followed according to any rules specific to the location and operation of the vehicle 102.

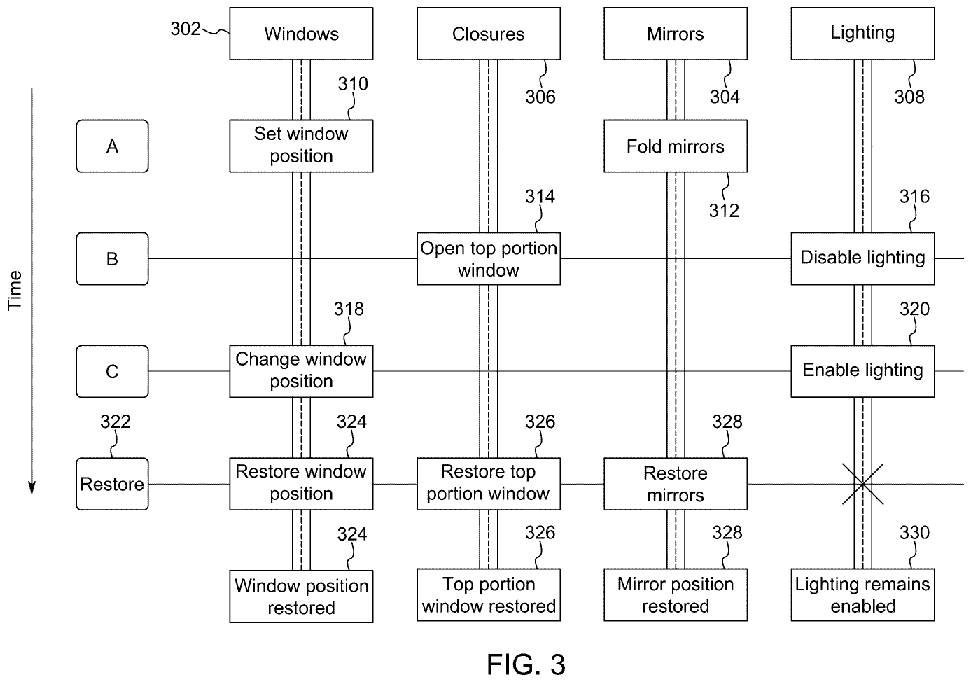

FIG. 2 depicts a block diagram of a system 200 to control operation of multiple vehicle automation modes simultaneously in accordance with the present disclosure. While describing FIG. 2, references will be made to FIGS. 3, 4 and 5.

The system 200 may include the vehicle 102, a user device 202 and one or more servers 204 (or a server 204) communicatively coupled with each other via one or more networks 206. In some aspects, the user device 202 may be associated with the user 104, and may be, for example, a mobile phone, a laptop, a tablet, a smartwatch, or any other device having communication capability. The server 204 may be part of a cloud-based computing infrastructure and may be associated with and/or include a Telematics Service Delivery Network (SDN) that provides digital data services to the vehicle 102 and other vehicles (not shown in FIG. 2) that may be part of a vehicle fleet.

In further aspects, the server 204 may store a mapping of a plurality of sets of vehicle components to be adjusted with a plurality of automation modes. For example, the server 204 may store a mapping that indicates that the operational states associated with a first set of vehicle components should be adjusted when the cinema mode 108 is activated in the vehicle 102, the operational states associated with a second set of vehicle components should be adjusted when the reading mode 110 is activated, the operational states associated with a third set of vehicle components should be adjusted when the cool comfort mode is activated, and so on. The first, second and third sets of vehicle components may or may not have common vehicle components between them. The server 204 may further store operational state information associated with an optimal operational state of each vehicle component, from the plurality of sets of vehicle components described above, for each automation mode from the plurality of automation modes. For example, the server 204 may store the operational state information that indicates first optimal operational states in which the first set of vehicle components should operate when the cinema mode 108 is activated in the vehicle 102, second optimal operational states in which the second set of vehicle components should operate when the reading mode 110 is activated, third optimal operational states in which the third set of vehicle components should operate when the cool comfort zone is activated, and so on. The examples of the first, second and third sets of vehicle components (i.e., the vehicle components associated with the cinema mode 108, the reading mode 110, and the cool comfort mode), and the first, second and third optimal operational states associated with the three example automation modes (i.e., the operational states in which the vehicle components operate in the respective automation modes) are described above in conjunction with FIG. 1.

In some aspects, the vehicle manufacturer and/or the user 104 may set and/or adjust/customize the mapping and/or the operational state information. In some aspects, multiple users may have different stored mappings for the vehicle's components with the automation modes as per their customization/preferences. Further, the server 204 may transmit the mapping and/or the operational state information to the vehicle 102 at a predefined frequency, or when the vehicle 102 transmits a request to the server 204 to obtain such information.

The network(s) 206 illustrates an example communication infrastructure in which the connected devices discussed in various embodiments of this disclosure may communicate. The network(s) 206 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 102 may include a plurality of units including, but not limited to, an automotive computer 208, a Vehicle Control Unit (VCU) 210, and an automation mode unit 212 (or unit 212). The VCU 210 may include a plurality of Electronic Control Units (ECUs) 214 in communication with the automotive computer 208.

In some aspects, the automotive computer 208 and/or the unit 212 may be installed anywhere in the vehicle 102, in accordance with the disclosure. Further, the automotive computer 208 may operate as a functional part of the unit 212. The automotive computer 208 may be or include an electronic vehicle controller, having one or more processor(s) 216 and a memory 218. Moreover, the unit 212 may be separate from the automotive computer 208 (as shown in FIG. 2) or may be integrated as part of the automotive computer 208.

The processor(s) 216 may be in communication with one or more memory devices in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable medium or memory storing a vehicle automation mode program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle 102 systems, connected servers (e.g., the server(s) 204), and other vehicles (not shown in FIG. 2) operating as part of a vehicle fleet. The VCU 210 may include or communicate with any combination of the ECUs 214, such as a Body Control Module (BCM) 220, an Engine Control Module (ECM) 222, a Transmission Control Module (TCM) 224, a Telematics Control Unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a radio detection and ranging (radar) sensor configured for detection and localization of objects inside and outside the vehicle 102 using radio waves, sitting area buckle sensors, sitting area sensors, a light detecting and ranging (lidar) sensor, door sensors, proximity sensors, temperature sensors, wheel sensors, ambient weather sensors, vehicle internal and external cameras, one or more rain sensors, capacitive moisture sensors, a tire pressure sensor, ultrasonic sensors, etc.

In some aspects, the VCU 210 may control vehicle operational aspects and implement one or more instruction sets received from the user device 202, from one or more instruction sets stored in the memory 218, including instructions operational as part of the unit 212.

The TCU 226 may be configured and/or programmed to provide vehicle connectivity to wireless computing systems onboard and off board the vehicle 102 and may include a Navigation (NAV) receiver 234 for receiving and processing a GPS signal, a BLE Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., the user device 202, a key fob, an NFC device, etc.), computers, and modules. The TCU 226 may be in communication with the ECUs 214 by way of a bus.

The ECUs 214 may control aspects of vehicle operation and communication using inputs from human drivers, inputs from an autonomous vehicle controller, the unit 212, and/or via wireless signal inputs received via the wireless connection(s) from other connected devices, such as the user device 202, the server(s) 204, among others.

The BCM 220 generally includes integration of sensors, vehicle performance indicators, and variable reactors associated with vehicle systems and may include processor-based power distribution circuitry that can control functions associated with the vehicle body such as lights, windows, security, camera(s), fan, headlights, audio system(s), speakers, wipers, door locks and access control, mirrors, various comfort controls, enclosures, and/or the like. The BCM 220 may also operate as a gateway for bus and network interfaces to interact with remote ECUs (not shown in FIG. 2). In some aspects, the BCM 220 may be configured to adjust the operational states of one or more vehicle components when an automation mode is activated/executed in the vehicle 102, based on inputs or command signals obtained from the user device 202, the key fob, the processor 216, the unit 212, and/or the like.

The DAT controller 228 may provide Level-1 through Level-3 automated driving and driver assistance functionality that may include, for example, active parking assistance, vehicle backup assistance, and adaptive cruise control, among other features. The DAT controller 228 may also provide aspects of user and environmental inputs usable for user authentication.

In some aspects, the automotive computer 208 may connect with the HMI 106 or an infotainment system 106 (hereinafter referred to as infotainment system 106). The infotainment system 106 may include a touchscreen interface portion and may include voice recognition features, biometric identification capabilities that can identify users based on facial recognition, voice recognition, fingerprint identification, or other biological identification means. In other aspects, the infotainment system 106 may be further configured to receive user instructions/inputs via the touchscreen interface portion and/or display notifications/recommendations, navigation maps, etc. on the touchscreen interface portion.

The computing system architecture of the automotive computer 208, the VCU 210, and/or the unit 212 may omit certain computing modules. It should be readily understood that the computing environment depicted in FIG. 2 is an example of a possible implementation according to the present disclosure, and thus, it should not be considered limiting or exclusive.

In accordance with some aspects, the unit 212 may be integrated with and/or executed as part of the ECUs 214. The unit 212, regardless of whether it is integrated with the automotive computer 208 or the ECUs 214, or whether it operates as an independent computing system in the vehicle 102, may include a transceiver 238, a processor 240, and a computer-readable memory 242.

The transceiver 238 may be configured to receive information/inputs from one or more external devices or systems, e.g., the user device 202, the server(s) 204, and/or the like via the network 206. For example, the transceiver 238 may receive the mapping and the operational state information described above from the user device 202 and/or the server 204 via the network 206. As another example, the transceiver 238 may receive triggers signals or requests from the user device 202, the VCU 210, the infotainment system 106, and/or the like, for activation and deactivation of one or more automation modes associated with the vehicle 102. Further, the transceiver 238 may transmit notifications (e.g., alert/alarm signals) to the external devices or systems. In addition, the transceiver 238 may be configured to receive information/inputs from vehicle 102 components such as the infotainment system 106, the vehicle sensory system 232, the TCU 226, and/or the like. Further, the transceiver 238 may transmit notifications (e.g., alert/alarm/command signals) to the vehicle 102 components such as the infotainment system 106, the BCM 220, etc.

The processor 240 and the memory 242 may be the same as or similar to the processor 216 and the memory 218, respectively. In some aspects, the processor 240 may utilize the memory 242 to store programs in code and/or to store data for performing aspects in accordance with the disclosure. The memory 242 may be a non-transitory computer-readable medium or memory storing the vehicle automation mode program code. In some aspects, the memory 242 may be configured to store the mapping and the operational state information described above that the vehicle 102 obtains from the server 204, the user device 202, and/or the like. In additional or alternative aspects, the vehicle 102 (and hence the memory 242) may obtain the mapping and the operational state information directly from the user 104 and/or the vehicle manufacturer via the infotainment system 106.

In operation, when the user 104 desires to execute two or more automation modes simultaneously in the vehicle 102, the user 104 may transmit, via the user device 202 or the infotainment system 106, the multiple automation mode request to the transceiver 238, as described above in conjunction with FIG. 1. The transceiver 238 may transmit the multiple automation mode request to the processor 240. Responsive to obtaining the multiple automation mode request, the processor 240 may enable the vehicle 102 to execute multiple automation modes simultaneously or enable/activate a “multiple automation mode” in the vehicle 102. When the multiple automation mode is activated, the vehicle 102 may execute a new automation mode “on top of” a previous automation mode such that both the automation modes execute/run simultaneously in the vehicle 102.

Responsive to the multiple automation mode getting activated in the vehicle 102, the user 104 may transmit, via the user device 202 or the infotainment system 106, trigger signals or requests to the transceiver 238 to activate/execute one or more automation modes simultaneously in the vehicle 102 (or the VCU 210 may transmit the trigger signals to the transceiver 238). In some aspects, the user 104 may transmit all the trigger signals/requests together or at the same time to the transceiver 238. In other aspects, the user 104 may transmit the trigger signals/requests sequentially (i.e., one-by-one) to the transceiver 238. As an example, the user 104 may transmit to the transceiver 238 a first trigger signal associated with a request to activate a first automation mode (shown as mode “A” in FIG. 3) in the vehicle 102, a second trigger signal associated with a request to activate a second automation mode (shown as mode “B”), a third trigger signal associated with a request to activate a third automation mode (shown as mode “C”), and so on, all at once or in a sequential manner. The transceiver 238 may transmit the received first, second and third trigger signals to the processor 240.

The processor 240 may obtain the first, second and third trigger signals from the transceiver 238. Responsive to obtaining the first, second and third trigger signals, the processor 240 may fetch the mapping and the operational state information from the memory 242. The processor 240 may then determine, based on the fetched mapping, a first set of vehicle components associated with the first automation mode (mode “A”) whose operational state should be adjusted when the first automation mode is activated/executed, a second set of vehicle components associated with the second automation mode (mode “B”) whose operational state should be adjusted when the second automation mode is activated/executed, and a third set of vehicle components associated with the third automation mode (mode “C”) whose operational state should be adjusted when the third automation mode is activated/executed. As an example, the processor 240 may determine, based on the mapping, that the operational states of windows 302 and mirror 304 (which may be examples of the first set of vehicle components) should be adjusted when the mode “A” is activated/executed, the operational states of vehicle closures 306 and lighting 308 (which may be examples of the second set of vehicle components) should be adjusted when the mode “B” is activated/executed, and the operational states of the windows 302 and the lighting 308 (which may be examples of the third set of vehicle components) should be adjusted when the mode “C” is activated/executed, as shown in FIG. 3.

The processor 240 may further determine, based on the fetched operational state information, first optimal operational states in which the first set of vehicle components should operate when the first automation mode is activated/actuated, second optimal operational states in which the second set of vehicle components should operate when the second automation mode is activated/actuated, and third optimal operational states in which the third set of vehicle components should operate when the third automation mode is activated/actuated. As an example, the processor 240 may determine, based on the operational state information, that the windows 302 should be set at a predefined position (shown as a block 310) and the mirrors 304 should be folded (shown as a block 312; blocks 310 and 312 may be examples of the first optimal operational states) when the mode “A” is activated/actuated, the closure 306 or the top portion window should be opened (shown as a block 314) and the lighting 308 should be disabled (shown as a block 316; blocks 314 and 316 may be examples of the second optimal operational states) when the mode “B” is activated/actuated, and the window 302 position should be changed (shown by a block 318) and the lighting 308 should be enabled (shown as a block 320; blocks 318 and 320 may be examples of the third optimal operational states) when the mode “C” is activated/actuated, as shown in FIG. 3.

Responsive to determining the first, second and third sets of vehicle components, and/or the associated first, second and third optimal operational modes as described above, the processor 240 may determine whether any vehicle component is common between the first, second and third sets of vehicle components. When the processor 240 determines that no vehicle component is common between the first, second and third sets of vehicle components, the processor 240 may cause, via the BCM 220, the first, second and third sets of vehicle components to operate in their respective first, second and third optimal operational modes. For example, as shown in FIG. 3, there is no common vehicle component between the vehicle components associated with the mode “A” (i.e., the windows 302 and the mirrors 304) and the vehicle components associated with the mode “B” (i.e., the closure 306 and the lighting 308). In this case, the processor 240 may cause the windows 302 and the mirrors 304 to operate based on their respective optimal operational modes associated with the mode “A”, and the closure 306 and the lighting 308 to operate based on their respective optimal operational modes associated with the mode “B”.

On the other hand, in some aspects, when the processor 240 determines that one or more vehicle components may be common between the first, the second and/or the third sets of vehicle components, the processor 240 may determine a priority order of activating the first, second and third automation modes. In alternative aspects, the processor 240 may determine the priority order of activating the first, second and third automation modes when the processor 240 obtains the first, second and third trigger signals, irrespective of whether any vehicle component is common between the first, second and third sets of vehicle components.

The priority order may define an “importance” or “priority” of one automation mode over the other. In some aspects, the priority order associated with the first, second and third automation modes may be based on a sequence in which the processor 240 obtains the associated first, second and third trigger signals. In an exemplary aspect, the automation mode whose trigger signal is obtained later has a higher/greater priority than the automation modes whose trigger signals are obtained previously or in the past. For example, as shown in FIG. 3, since the trigger signal associated with the mode “B” is obtained later than the trigger signal associated with the mode “A”, the mode “B” has a higher priority than the mode “A”. Similarly, since the trigger signal associated with the mode “C” is obtained later than the trigger signal associated with the mode “B”, the mode “C” has a higher priority than the mode “B”. The example described above may be associated with a scenario when the user 104 transmits the trigger signals (e.g., the first, second and third trigger signals) to the vehicle 102 in a sequential manner (i.e., one after the other).

In other aspects, the priority order associated with the first, second and third automation modes may be based on user preferences or inputs obtained from the user 104. For example, when the user 104 forms or builds a list/stack of automation modes to be executed simultaneously on the user device 202 or the infotainment system 106 and/or transmits the first, second and third trigger signals simultaneously/together to the vehicle 102, the user 104 may additionally transmit user preferences or inputs associated with the priority order in which the user 104 desires the automation modes to execute. For example, while building the stack of automation modes on the user device 202 or the infotainment system 106, the user 104 may provide an input indicating that the mode “C” should have a higher priority than the mode “B”, and the mode “B” should have a higher priority than the mode “A”. The user 104 may also modify or update the priority order any time on the user device 202 or the infotainment system 106, when the automation modes may be getting executed in the vehicle 102. When the priority order is updated or modified, the vehicle 102/processor 240 may “reapply” all the automation modes running in the vehicle 102, according to the modified or updated priority order of the automation modes. As an example, the user 104 may update the priority order indicating which automation mode can “override” others and be “expressed”, in the modified or updated priority order.

Responsive to determining the priority order as described above, the processor 240 may determine that the mode “C” has a higher priority than the mode “B”, and the mode “B” has a higher priority than the mode “A”, based on the priority order. Responsive to such determination, the processor 240 may cause the vehicle components common between the second and third sets of vehicle components (i.e., vehicle components common between the modes “C” and “B”) to operate in the third optimal operational mode (i.e., the operational mode associated with the mode “C”), and the remaining vehicle components in the second set of vehicle components to operate in the second optimal operational mode (i.e., the operational mode associated with the mode “B”) simultaneously. Similarly, the processor 240 may cause the vehicle components common between the first and second sets of vehicle components (i.e., common between the modes “B” and “A”) to operate in the second optimal operational mode (i.e., the operational mode associated with the mode “B”), and the remaining vehicle components in the first set of vehicle components to operate in the first optimal operational mode (i.e., the operational mode associated with the mode “A”) simultaneously.

In this manner, when the vehicle components are common between two automation modes that the user 104 desires to activate/execute simultaneously, the processor 240 adjusts the operational state of the “common” vehicle components based on the automation mode that has the higher priority. As an example, as shown in FIG. 3, the processor 240 causes a change in window position (shown by the block 318) from its earlier set position (shown by the block 310) when the mode “C” is executed, as the priority associated with the mode “C” is higher than the mode “A”. Similarly, the processor 240 enables the lighting 308 (shown by the block 320) when the mode “C” is executed from its earlier state of being disabled (shown by the block 316), as the priority associated with the mode “C” is higher than the mode “B”.

In further aspects, before making any change in the operational states associated with the first, second and third sets of vehicle components described above, the processor 240 may determine their pre-automation operational states based on inputs obtained from the VCU 210. In some aspects, the processor 240 may determine the pre-automation operational states associated with the first, second and/or third sets of vehicle components responsive to obtaining the first, second and/or third trigger signals from the user 104. In an exemplary aspect, the pre-automation operational states may be the current operational states associated with the first, second and third sets of vehicle components before the first, second and third sets of vehicle components are caused to operate by the processor 240 in their respective optimal operational states (e.g., the first, second and third optimal operational states). In additional or alternative aspects, the pre-automation operational states may be the operational states associated with the vehicle components before any automation mode was running/executing in the vehicle 102 (e.g., before the first automation mode/mode “A” was activated in the vehicle 102).

Responsive to determining the pre-automation operational states associated with the first, second and/or third sets of vehicle components as described above, the processor 240 may store information associated with the pre-automation operational states in the memory 242. The processor 240 may use the information associated with the pre-automation operational states when the user 104 desires to deactivate or switch OFF one or more automation modes, as described below.

When the user 104 desires to deactivate or switch OFF all the automation modes being executed in the vehicle 102 (e.g., the first, second and third automation modes, or modes “A”, “B” and “C”), the user 104 may transmit, via the user device 202 or the infotainment system 106, a fourth trigger signal associated with a vehicle automation mode deactivation request to the transceiver 238. The transceiver 238 may transmit the fourth trigger signal to the processor 240. The processor 240 may obtain the fourth trigger signal, and fetch the information associated with the pre-automation operational states from the memory 242 responsive to obtaining the fourth trigger signal. The processor 240 may then restore, via the BCM 220, the operational states associated with the first, second and third sets of vehicle components to their respective pre-automation operational states (when no automation was being executed in the vehicle 102) based on the fetched information associated with the pre-automation operational states.

For example, as shown in FIG. 3, responsive to obtaining the fourth trigger signal or the vehicle automation mode deactivation request (shown as a block restore 322), the processor 240 may restore the operational states associated with the windows 302, the closures 306 (or the top portion window) and the mirrors 304 to their respective pre-automation operational states (as shown by blocks 324, 326 and 328).

In further aspects, the vehicle 102 may enable the user 104 to cause one or more vehicle components to continue operating in their existing operational modes even when the vehicle automation mode is deactivated. In this case, the user 104 may transmit, via the user device 202 or the infotainment system 106, an input to the transceiver 238 indicating the vehicle component whose operational mode should not be altered when the vehicle automation mode is deactivated or when the processor 240 obtains the fourth trigger signal. The transceiver 238 may transmit the input to the processor 240, which may cause the indicated vehicle component to continue operation in its existing operational state even after the vehicle automation mode is deactivated. For example, as shown by a block 330 in FIG. 3, the processor 240 may not alter the operational state associated with the lighting 308, when the user 104 indicates in the input that the lighting's state should be kept in its existing operational state even after the vehicle automation mode is deactivated.

In some aspects, the “input”, as described above, may be part of the vehicle's or automation mode's settings/configuration, and may be provided by the user 104 before the automation is run or executed in the vehicle 102. Stated another way, the user 104 is not necessarily required to provide the input described above when the automation is running, but may alternatively or additionally provide the input when the vehicle 102 or the automation modes may be getting configured. In additional or alternative aspects, the user 104 may also indicate that the items/vehicle components the user 104 interacts with during the automation should be designated in this manner without needing to do so specifically.

In additional or alternative aspects, the input transmitted by the user 104 may indicate a default operational state of one or more vehicle components from the first, second and/or third sets of vehicle components. The default operational state may indicate an operational state of a vehicle component desired by the user 104 when the vehicle automation mode is deactivated. For example, the user 104 may indicate in the input that the lighting 308 should always be enabled (i.e., its default operational state) whenever the vehicle automation mode is deactivated. In this case, responsive to obtaining the input from the user 104, the processor 240 may cause the vehicle component(s) indicated by the user 104 to operate in its default operational state when the processor 240 deactivates the vehicle automation mode or when the processor 240 obtains the fourth trigger signal.

In further aspects, the vehicle 102 may enable the user 104 to manually set or change, via the user device 202 or the infotainment system 106, the operational states of one or more vehicle components from the first, second and/or third sets of vehicle components when these vehicle components may be operating in their respective optimal operational states. Stated another way, the vehicle 102 may enable the user 104 to manually set or change the operational states of one or more vehicle components from the first, second and/or third sets of vehicle components when the first, second and/or third automation modes (e.g., the modes “A”, “B” and/or “C”) may be getting executed in the vehicle 102. In this case, the user 104 may transmit, via the user device 202 or the infotainment system 106, user inputs associated with preferred operational states of one or more vehicle components from the first, second and/or third sets of vehicle components to the transceiver 238, when the first, second and/or third automation modes may be getting executed in the vehicle 102. The transceiver 238 may transmit the user inputs to the processor 240, which may cause the vehicle components to operate in their respective preferred operational states responsive to obtaining the user inputs.

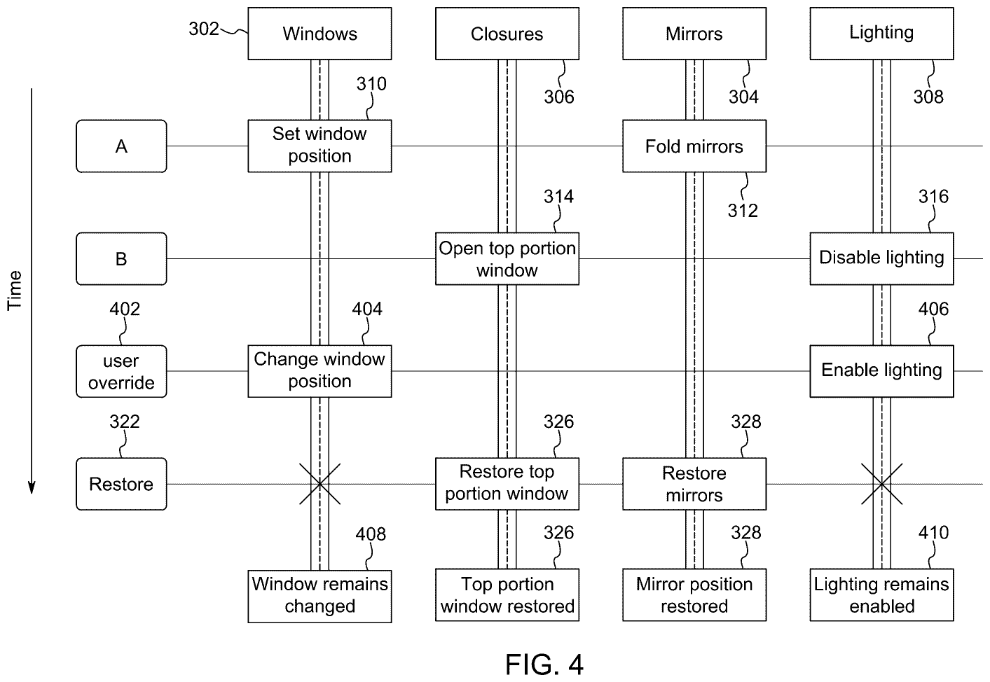

For example, as shown in FIG. 4, the user 104 may transmit/provide user inputs (shown as a block user override 402) to the transceiver 238/processor 240 indicating the preferred operational states associated with the windows 302 and the lighting 308 when the first and second automation modes (e.g., the modes “A” and “B”) may be getting executed in the vehicle 102. Responsive to obtaining the user inputs/override 402, the processor 240 may cause a change in window's operational state (shown as a block 404) and enable the lighting 308 (shown as a block 406) based on the preferred operational states associated with these vehicle components as indicated in the user inputs.

Furthermore, in this case, when the processor 240 obtains the fourth trigger signal or the vehicle automation mode deactivation request from the user 104, the processor 240 may not cause these vehicle components (e.g., the windows 302 and the lighting 308) to “go back” or revert to their respective pre-automation operational states. Instead, in this case, the processor 240 may cause these vehicle components to continue operation in the preferred operational states even after obtaining the fourth trigger signal, as shown by blocks 408 and 410 in FIG. 4. In this manner, the processor 240 gives preference/priority to the user's preferred operational states of vehicle components over their pre-automation operational states, when the processor 240 obtains the fourth trigger signal and restores the operational states associated with vehicle components.

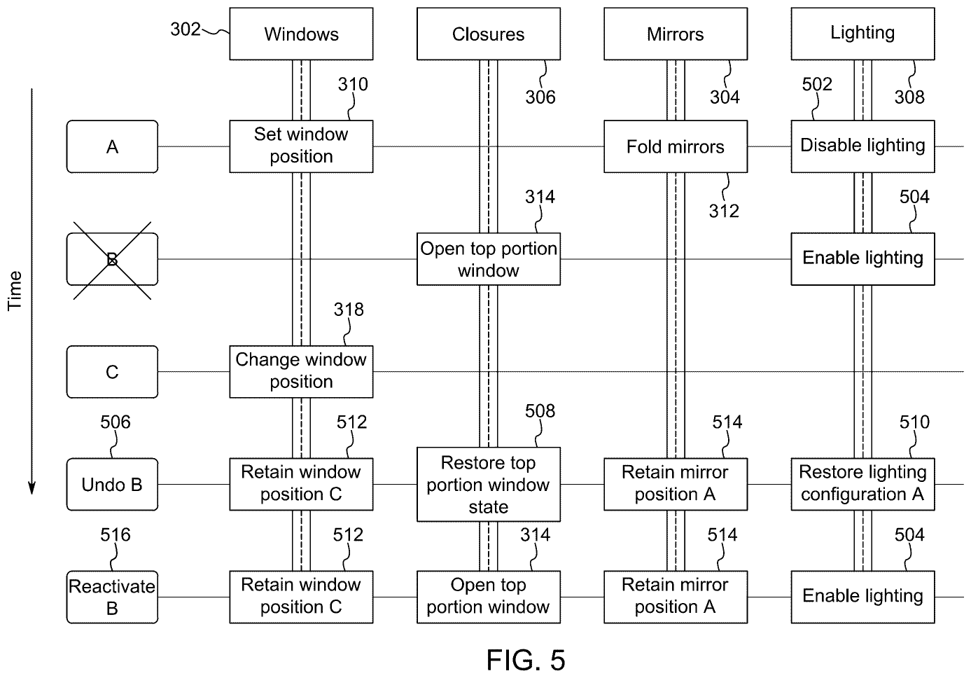

In yet another aspect, the vehicle 102 may enable the user 104 to deactivate or switch OFF one or more automation modes from a list of automation modes running/executing in the vehicle 102, while enabling the remaining automation modes to continue being executed. For example, when the first, second and third automation modes (e.g., the modes “A”, “B” and “C”) may be getting executed in the vehicle 102, the user 104 may deactivate or switch OFF an automation mode (e.g., the mode “B”), while keeping the remaining automation modes (e.g., the modes “A” and “C”) in the activated states. An example illustration of this aspect is shown in FIG. 5.

As shown in FIG. 5, when the mode “A” is activated, the processor 240 may set the window position (shown as the block 310), fold the mirrors 304 (shown as the block 312), and disable the lighting 308 (shown as a block 502). When the mode “B” is activated, the processor 240 may open the top portion window 306 (shown as the block 314) and enable the lighting 308 (shown as a block 504). Since the priority associated with the mode “B” is higher than the mode “A”, the processor 240 may change the operational state associated with the lighting 308 to the enabled state from the disabled state, as shown in FIG. 5, responsive to activating/executing the mode “B”. Further, when the mode “C” is activated, the processor 240 may change the window state (shown as the block 318) from its state shown in the block 310, as the priority associated with the mode “C” is higher than the mode “A”.

In this configuration, when the user 104 desires to deactivate an automation mode (e.g., the mode “B”) when the modes “A”, “B” and “C” may be getting executed in the vehicle 102, the user 104 may transmit, via the user device 202 or the infotainment system 106, the deactivation request to deactivate the mode “B” to the transceiver 238. Stated another way, the user 104 may transmit the deactivation request to deactivate the mode “B” to the transceiver 238 when the first, second and third sets of vehicle components may be operating in their respective optimal operational modes.

Responsive to receiving the deactivation request, the transceiver 238 may transmit the deactivation request to the processor 240, which may restore operational states of the vehicle components associated with the mode “B” (i.e., the second set of vehicle components) to their respective pre-automation operational states or to their respective operational states before the mode “B” was activated. For example, as shown in FIG. 5, responsive to obtaining the deactivation request for the mode “B” (shown as a block undo B 506), the processor 240 may restore the top portion window's operational state to its pre-automation operational state 508 (when no automation mode was running/executing in the vehicle 102), as the top portion window's operational state is not defined in the mode “A”. Further, the processor 240 may revert the operational state associated with the lighting 308 to its operational state in mode “A” (shown as a block retain lighting configuration A 510), as the operational state associated with the lighting 308 is defined in the mode “A”.

A person ordinarily skilled in the art may appreciate from the description above that in this manner, the processor 240 causes the vehicle components whose automation mode is deactivated to revert to their respective operational states associated with the automation mode having a lesser priority (or a predecessor automation mode, if available) or revert to their original pre-automation operational states.

Furthermore, in this case, the processor 240 may not alter the operational states associated with the vehicle components that are not mapped to the deactivated automation mode (e.g., the mode “B”). For example, as shown in FIG. 5, responsive to obtaining the deactivation request to deactivate the mode “B”, the processor 240 may not alter or may retain operational states associated with the windows 302 and the mirrors 304 (shown as blocks 512 and 514), as these vehicle components are not associated or mapped with the deactivated mode “B”.

In further aspects, in addition to adjusting the operational states of the vehicle components associated with the deactivated mode “B” as described above, the processor 240 may store in the memory 242 a priority information associated with a priority position of the deactivated mode “B” in the priority order of activating the first, second and third automation modes (e.g., the modes “A”, “B” and “C”), responsive to obtaining the deactivation request. For example, the processor 240 may store the information indicating that the priority associated with the deactivated mode “B” is higher than the mode “A” but lesser than the mode “C”. The processor 240 may use this stored information when the user 104 reactivates the mode “B”, as described below and shown by a block 516 in FIG. 5.

The vehicle 102 may further enable the user 104 to reactivate an automation mode that the user 104 deactivated previously (e.g., the mode “B”) when the remaining automation modes (e.g., the modes “A” and “C”) may still be running/executing in the vehicle 102. In this case, the user 104 may transmit, via the user device 202 or the infotainment system 106, a request to reactivate the mode “B” (or a reactivation request, shown by the block 516) to the transceiver 238 when the user 104 desires to reactivate the mode “B” and when the modes “A” and “C” may still be running/executing in the vehicle 102. The transceiver 238 may transmit the reactivation request to the processor 240, which may determine the priority position associated with the mode “B” in the priority order based on the priority information stored in the memory 242, responsive to obtaining the reactivation request. The processor 240 may further adjust the operational states of the vehicle components associated with the mode “B” based on the priority position. Specifically, in this case, although the reactivation request associated with the mode “B” is obtained after the activation request for the mode “C”, the processor 240 may still not treat the mode “B” as the highest priority automation mode over the mode “C”, as the mode “B” had a lower priority than the mode “C” in the original priority order. Therefore, in this case, the processor 240 may adjust the operational modes associated with the top portion window 306 and the lighting 308 (e.g., the second set of vehicle components) based on the mode B's original priority order, thereby preventing any occurrence of inconvenience for the user 104.

For example, in this case, when the mode “B” is reactivated, the processor 240 may retain the position of the windows 302 as per mode “C” (as shown by the block 512 in FIG. 5), as the priority of mode “C” is greater than mode “B” (and also as the windows 302 are not associated with mode “B”). The processor 240 may further open the top window portion 306, as per mode “B”, as shown by the block 314. The processor 240 may additionally retain the position of the mirrors 304 as per the mode “A”, as shown by the block 514. The processor 240 may further enable the lighting 308 as per mode “B” (as shown by the block 504), as the priority of mode “B” is greater than mode “A”.

A person ordinarily skilled in the art may appreciate from the description above that the purpose of storing the priority information/list is that, without it, the mode “B” would not behave as expected (i.e., how it behaved the first time) if it were stopped/deactivated and then resumed/reactivated. Storing the priority information/list prevents any inconvenience for the user 104.

Although the description above describes an aspect where the transceiver 238/processor 240 obtains the trigger signals for activation or deactivation of automation modes from the user 104 via the user device 202 or the infotainment system 106, the present disclosure is not limited to such an aspect. In some aspects, the transceiver 238/processor 240 may obtain a trigger signal to activate or deactivate an automation mode from the VCU 210, based on settings or inputs provided by the user 104. For example, as described above in conjunction with FIG. 1, when the user 104 prefers the “cool comfort mode” to automatically get executed in the vehicle 102 when the vehicle's speed drops below 5 miles an hour, the VCU 210 may generate a trigger signal when the vehicle's speed drops below 5 miles an hour. In this case, the processor 240 may obtain the trigger signal from the VCU 210, and automatically activate the “cool comfort mode” when the vehicle's speed drops below 5 miles an hour responsive to obtaining the trigger signal from the VCU 210.

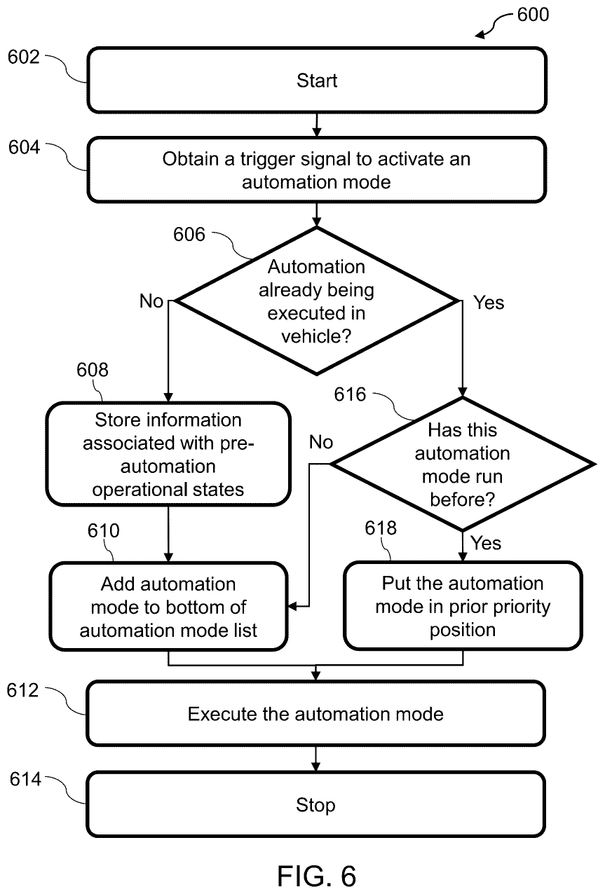

FIG. 6 depicts a flow diagram of an example first method 600 to control vehicle component operation in accordance with the present disclosure. FIG. 6 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 600 starts at step 602. At step 604, the method 600 may include obtaining, by the processor 240, a trigger signal to activate an automation mode (e.g., the mode “B”). At step 606, the method 600 may include determining, by the processor 240, whether any automation mode (e.g., the modes “A” and/or “C”) may already be running/executing in the vehicle 102. Responsive to determining that no automation mode is already running in the vehicle 102 at the step 606, the processor 240 may store the information associated with the pre-automation operational modes of the vehicle components associated with the mode “B” at step 608, and add the mode “B” to the bottom of an automation mode list at step 610. In some aspects, the automation mode at the bottom of the automation mode list has the highest priority.

At step 612, the method 600 may include executing, by the processor 240, the mode “B”. At step 614, the method 600 may end.

On the other hand, responsive to determining that one or more automation modes (e.g., the modes “A” and/or “C”) may already be running in the vehicle 102 at the step 606, the processor 240 may determine whether the mode “B” was run before at step 616. Responsive to determining that the mode “B” was run before at the step 616, the processor 240 may put the mode “B” in the prior priority position in the priority order at step 618, and then execute the mode “B” at the step 612. On the other hand, responsive to determining that the mode “B” was not run before at the step 616, the method 600 may move to the step 610 described above.

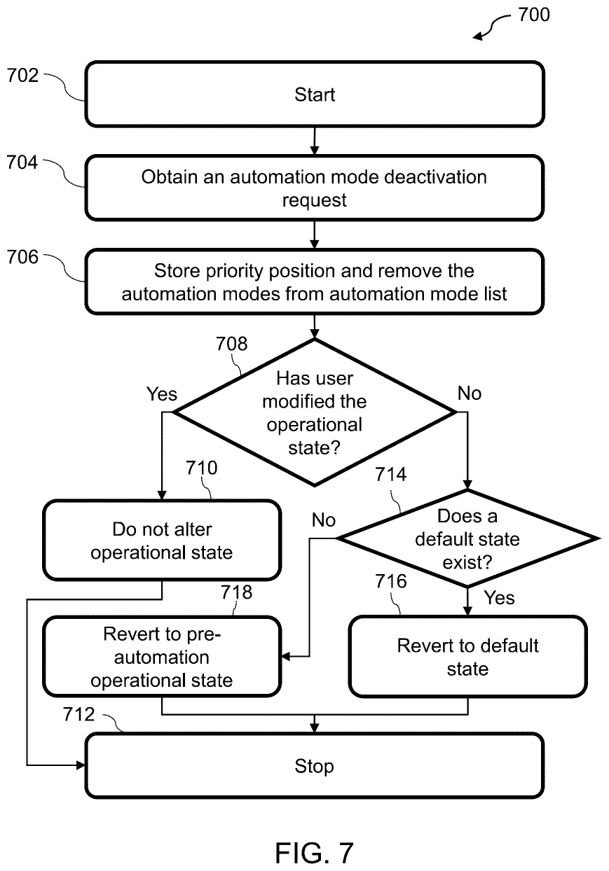

FIG. 7 depicts a flow diagram of an example second method 700 to control vehicle component operation in accordance with the present disclosure. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 700 starts at step 702. At step 704, the method 700 may include obtaining, by the processor 240, an automation mode deactivation request to deactivate one or more automation modes that may be running in the vehicle 102. At step 706, the method 700 may include storing, by the processor 240, the priority position(s) in the priority order of the automation mode(s) to be deactivated in the memory 242, and removing the automation mode(s) from the automation mode list.

At step 708, the method 700 may include determining, for each vehicle component associated with the automation mode(s) to be deactivated, whether the user 104 has modified the operational state. Responsive to determining that the user 104 has modified the operational state at the step 708, the processor 240 may not alter its operational state at step 710. At step 712, the method 700 may end.

On the other hand, responsive to determining that the user 104 has not modified the operational state at the step 708, the processor 240 may determine whether a default operational state exists for the vehicle component at step 714. Responsive to determining that a default operational state exists for the vehicle component at the step 714, the processor 240 may revert the operational state associated with the vehicle component to its default operational state at step 716. After the step 716, the method 700 moves to the step 712.

On the other hand, responsive to determining that a default operational state does not exist for the vehicle component at the step 714, the processor 240 may revert the operational state associated with the vehicle component to its pre-automation operational state at step 718. After the step 718, the method 700 moves to the step 712, at which the method 700 ends.

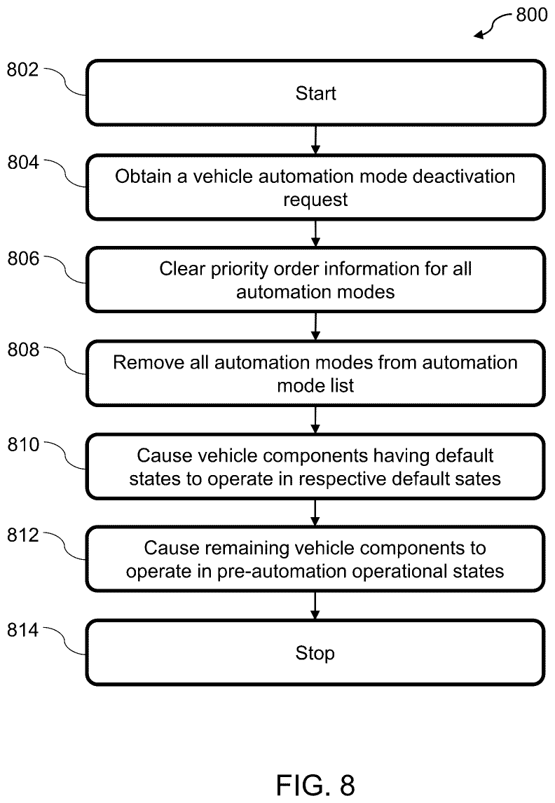

FIG. 8 depicts a flow diagram of an example third method 800 to control vehicle component operation in accordance with the present disclosure. FIG. 8 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 800 starts at step 802. At step 804, the method 800 may include obtaining, by the processor 240, a vehicle automation mode deactivation request to deactivate all automation modes running/executing in the vehicle 102. At step 806, the method 800 may include clearing, by the processor 240, the priority order information or priority position information associated with the priority order for all the automation modes from the memory 242.

At step 808, the method 800 may include removing, by the processor 240, all the automation modes from the automation mode list. At step 810, the method 800 may include causing, by the processor 240, one or more vehicle components associated with the automation modes having default operational states (or user preferred operational states) to operate in their respective default operational states (or user preferred operational states). At step 812, the method 800 may include causing, by the processor 240, the remaining vehicle components associated with the automation modes to operate in their respective pre-automation operational states.

At step 814, the method 800 may end.

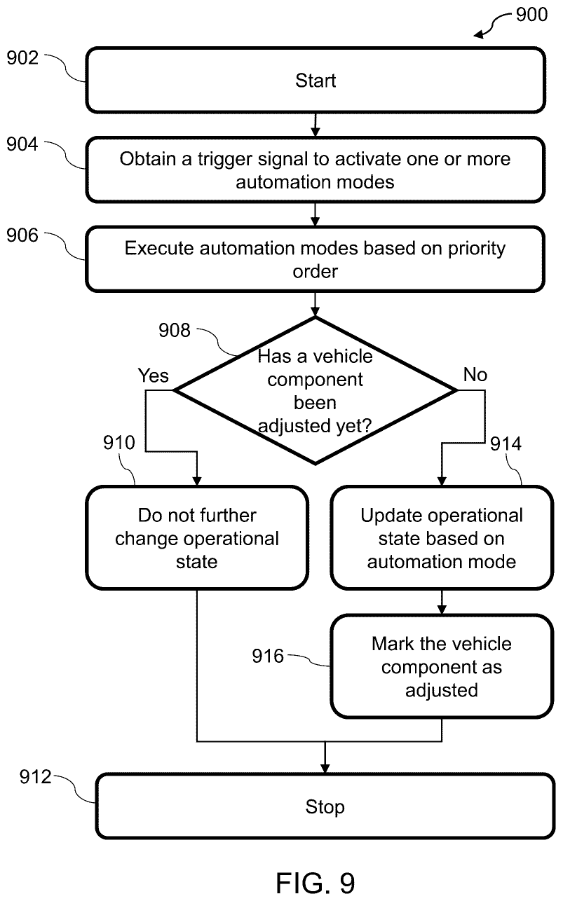

FIG. 9 depicts a flow diagram of an example fourth method 900 to control vehicle component operation in accordance with the present disclosure. FIG. 9 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 900 starts at step 902. At step 904, the method 900 may include obtaining, by the processor 240, a trigger signal to activate one or more automation modes. At step 906, the method 900 may include executing, by the processor 240, the automation modes based on their respective priority positions in the priority order. While executing the automation modes, for each vehicle component associated with the automation modes, the processor 240 may determine, at step 908, whether the vehicle component has already been adjusted.

Responsive to determining that the vehicle component has already been adjusted at the step 908, the processor 240 may not further alter the operational state associated with the vehicle component at step 910. At step 912, the method 900 may end.

On the other hand, responsive to determining that the vehicle component has not been adjusted at the step 908, the processor 240 may update the operational state associated with the vehicle component based on its respective automation mode or default state at step 914. At step 916, the method 900 may include marking, by the processor 240, the vehicle component as adjusted. After the step 916, the method 900 may move to the step 912, at which the method 900 may end.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A vehicle comprising:
a transceiver configured to receive trigger signals associated with activation and deactivation of a plurality of automation modes associated with the vehicle; and
a processor configured to:
obtain a first trigger signal associated with a request to activate a first automation mode and a second trigger signal associated with a request to activate a second automation mode;
determine first optimal operational states for a first set of vehicle components associated with the first automation mode, and second optimal operational states for a second set of vehicle components associated with the second automation mode, responsive to obtaining the first trigger signal and the second trigger signal; and
cause the first set of vehicle components to operate in the first optimal operational states and the second set of vehicle components to operate in the second optimal operational states simultaneously, when no vehicle component is common between the first set of vehicle components and the second set of vehicle components.

2. The vehicle of claim 1 further comprising a memory configured to store:
a mapping of a plurality of sets of vehicle components to be adjusted with the plurality of automation modes; and
an operational state information associated with an optimal operational state of each vehicle component, of the plurality of sets of vehicle components, for each automation mode of the plurality of automation modes.

3. The vehicle of claim 2, wherein the processor is further configured to:
fetch the mapping and the operational state information from the memory, responsive to obtaining the first trigger signal and the second trigger signal;
determine the first set of vehicle components and the second set of vehicle components based on the mapping; and
determine the first optimal operational states associated with the first set of vehicle components and the second optimal operational states associated with the second set of vehicle components based on the operational state information.

4. The vehicle of claim 1, wherein the processor is further configured to:
determine that one or more first vehicle components are common between the first set of vehicle components and the second set of vehicle components; and
determine a priority order of activating the first automation mode and the second automation mode, responsive to determining that the one or more first vehicle components are common between the first set of vehicle components and the second set of vehicle components.

5. The vehicle of claim 4, wherein the processor is further configured to:
determine that the second automation mode has a higher priority of activation than the first automation mode based on the priority order; and
cause the one or more first vehicle components to operate in the second optimal operational states and remaining vehicle components of the first set of vehicle components to operate in the first optimal operational states simultaneously, responsive to determining that the second automation mode has the higher priority.

6. The vehicle of claim 4, wherein the priority order is based on a sequence of obtaining the first trigger signal and the second trigger signal.

7. The vehicle of claim 4, wherein the priority order is based on user preferences obtained from a vehicle user.

8. The vehicle of claim 1, wherein the processor is further configured to:
determine pre-automation operational states associated with at least one of the first set of vehicle components or the second set of vehicle components responsive to obtaining at least one of the first trigger signal or the second trigger signal, wherein the pre-automation operational states are current operational states of the first set of vehicle components and the second set of vehicle components before the first set of vehicle components and the second set of vehicle components are caused to operate in the first optimal operational states and the second optimal operational states respectively; and
store an information associated with the pre-automation operational states.

9. The vehicle of claim 8, wherein the processor is further configured to obtain a third trigger signal associated with a vehicle automation mode deactivation request.

10. The vehicle of claim 9, wherein the processor is further configured to:
fetch the information associated with the pre-automation operational states, responsive to obtaining the third trigger signal; and
restore operational states of the first set of vehicle components and the second set of vehicle components back to their respective pre-automation operational states based on the information, responsive to obtaining the third trigger signal.

11. The vehicle of claim 9, wherein the processor is further configured to:
obtain inputs associated with a default operational state of at least one vehicle component of at least one of the first set of vehicle components or the second set of vehicle components; and
cause the at least one vehicle component to operate in the default operational state, responsive to obtaining the third trigger signal.

12. The vehicle of claim 9, wherein the processor is further configured to:
obtain user inputs associated with preferred operational states of one or more second vehicle components of at least one of the first set of vehicle components or the second set of vehicle components, when the first set of vehicle components is operating in the first optimal operational states or the second set of vehicle components is operating in the second optimal operational states; and
cause the one or more second vehicle components to operate in the preferred operational states responsive to obtaining the user inputs.

13. The vehicle of claim 12, wherein the processor is further configured to cause the one or more second vehicle components to continue operation in the preferred operational states responsive to obtaining the third trigger signal.

14. The vehicle of claim 8, wherein the processor is further configured to:
obtain a deactivation request to deactivate the first automation mode, when the first set of vehicle components is operating in the first optimal operational states and the second set of vehicle components is operating in the second optimal operational states; and
restore operational states of the first set of vehicle components to respective pre-automation operational states responsive to obtaining the deactivation request.

15. The vehicle of claim 14, wherein the processor is further configured to store a priority information associated with a priority position of the first automation mode in a priority order of activating the first automation mode and the second automation mode, responsive to obtaining the deactivation request.

16. The vehicle of claim 15, wherein the processor is further configured to:
obtain a request to reactivate the first automation mode after obtaining the deactivation request when the second set of vehicle components is operating in the second optimal operational states;
determine the priority position of the first automation mode in the priority order based on the priority information, responsive to obtaining the request to reactivate the first automation mode; and
adjust operational states associated with the first set of vehicle components based on the priority position.

17. The vehicle of claim 1, wherein the transceiver receives the trigger signals from a user device, a vehicle Human-Machine Interface (HMI) or a vehicle control unit.

18. A method comprising:
obtaining, by a processor, a first trigger signal associated with a request to activate a first automation mode and a second trigger signal associated with a request to activate a second automation mode;
determining, by the processor, first optimal operational states for a first set of vehicle components associated with the first automation mode, and second optimal operational states for a second set of vehicle components associated with the second automation mode, responsive to obtaining the first trigger signal and the second trigger signal; and
causing, by the processor, the first set of vehicle components to operate in the first optimal operational states and the second set of vehicle components to operate in the second optimal operational states simultaneously, when no vehicle component is common between the first set of vehicle components and the second set of vehicle components.

19. The method of claim 18 further comprising:
determining that one or more first vehicle components are common between the first set of vehicle components and the second set of vehicle components;
determining a priority order of activating the first automation mode and the second automation mode, responsive to determining that the one or more first vehicle components are common between the first set of vehicle components and the second set of vehicle components;
determining that the second automation mode has a higher priority of activation than the first automation mode based on the priority order; and
causing the one or more first vehicle components to operate in the second optimal operational states and remaining vehicle components of the first set of vehicle components to operate in the first optimal operational states simultaneously, responsive to determining that the second automation mode has the higher priority.

20. A non-transitory computer-readable storage medium having instructions stored thereupon which, when executed by a processor, cause the processor to:
obtain a first trigger signal associated with a request to activate a first automation mode and a second trigger signal associated with a request to activate a second automation mode;
determine first optimal operational states for a first set of vehicle components associated with the first automation mode, and second optimal operational states for a second set of vehicle components associated with the second automation mode, responsive to obtaining the first trigger signal and the second trigger signal; and
cause the first set of vehicle components to operate in the first optimal operational states and the second set of vehicle components to operate in the second optimal operational states simultaneously, when no vehicle component is common between the first set of vehicle components and the second set of vehicle components.
